(19) United States
(12) Patent Application Publication
(10) Pub. No.: US 2014/0010923 A1
(43) Pub. Date: Jan. 9, 2014

(54) METHOD FOR FLAVORING CORN BEANS FOR POPCORN AND CORN BEAN PRODUCT OBTAINED BY SAID METHOD

(71) Applicants: Fatima Gomez Arroyo, Reus (ES); Juan Ramon Duran Vila, Reus (ES)

(72) Inventors: Fatima Gomez Arroyo, Reus (ES); Juan Ramon Duran Vila, Reus (ES)

(73) Assignee: TANIO, S. A. (SOCIEDAD UNIPERSONAL), REUS (ES)

(21) Appl. No.: 14/006,139

(22) PCT Filed: Mar. 22, 2012
(86) PCT No.: PCT/IB12/51368

§ 371 Date: Sep. 19, 2013

(30) Foreign Application Priority Data
Mar. 22, 2011 (ES) P201130410

(51) Int. Cl. A23L 1/18

(52) U.S. Cl. CPC A23L 1/18
USPC 426/89; 426/272

(57) ABSTRACT

The method comprises the steps of: i) applying a portion of adhesive liquid on the unpopped kernels, comprising said adhesive liquid an aqueous based adhesive composition; ii) after step i), applying a portion of flavorant on said kernels, keeping said kernels under movement at a temperature from 50° C. to 70° C. for enough time in order to allow the evaporation of water from said adhesive liquid, iii) cyclically repeating steps i) and ii) until each of said steps is carried out at least two times while said kernels are kept at a temperature from 50° C. to 70° C., the repetition of said steps I) and ii) allowing the formation of a coating film over the kernel, said coating film comprising a plurality of layers of adhesive and flavorant. The product is characterized in that said kernels comprise at least 4.5% by weight of flavorant with respect to the total weight of the unpopped kernel. It has been observed that the waste of flavorant is reduced very significantly, the application efficiency being very higher.

The present invention refers to a method for flavoring unpopped popcorn kernels and to an unpopped popcorn kernel product obtained by said method.

### BACKGROUND OF THE INVENTION

The marketing of unpopped kernels packed in bags for microwaves with fat or oil including a suspension flavorant is known. When the kernels are popped, this fat or oil is used as vehicle for the flavorant, making easier to obtain an expanded product ready to be consumed.

The use of fat or oil for flavoring unpopped kernels has a lot of drawbacks. On one hand, the addition of fat or oil requires the use of specific packages resistant for lipid contact, not resulting suitable any kind of package. On the other hand, the addition of fat or oil increases the caloric charge of a product that itself has a lot of calories.

Flavoring processes of unpopped kernels comprising the steps of applying an adhesive liquid and a flavorant on the unpopped popcorn kernels to form a flavorant coating layer on the hull of the kernels are known. U.S. Pat. No. 5,753,287, U.S. Pat. No. 5,688,543, FR2680082 and U.S. Pat. No. 4767635 disclose processes of this kind.

The processes disclosed in these patents have the advantage that they permit to obtain an unpopped kernel more or less flavored that can be packaged directly in microwave packages with no fat or oil, or to use e.g. in hot air machines, to obtain popped kernels directly flavored.

Said flavoring processes try to obtain an uniform coating layer strongly adhered that persists during the packaging phase and the expansion phase to guarantee the presence of flavorant. However, in the practice, it has been observed that the kernels treated with these processes have important coating losses after they are popped, which produce a flavor loss. Furthermore, it has been observed that during the flavoring steps important waste of flavorant is produced.

### DESCRIPTION OF THE INVENTION

The object of the present invention is to solve said drawbacks, developing a flavoring method for unpopped popcorn kernels that has the advantage that substantially reduces the waste of flavorant of the state of the art processes, and the advantage that it obtains an unpopped popcorn kernel product with more flavorant and less coating losses after its explosion.

According to this objective, the present invention provides a method for flavoring unpopped popcorn kernels comprising the steps of:
i) applying a portion of adhesive liquid on the unpopped kernels, comprising said adhesive liquid an aqueous based adhesive composition;
ii) after step i), applying a portion of flavorant on said kernels, keeping said kernels under movement at a temperature from 50° C. to 70° C. for enough time in order to allow the evaporation of water from said adhesive liquid,
iii) cyclically repeating steps i) and ii) until each of said steps is carried out at least two times while said kernels are kept at a temperature from 50° C. to 70° C., the repetition of said steps i) and ii) allowing the formation of a coating film over the kernel, said coating film comprising a plurality of layers of adhesive and flavorant.

In the process of the present invention, the flavorant is applied in different steps, alternating adhesive liquid and flavorant layers, and keeping the kernels at a temperature from 50° C. to 70° C. Thanks to this feature, it has been observed that the waste of flavorant is reduced very significantly, being the application efficiency very higher.

On the other hand, it has been observed that, differently from the state of the art processes, the claimed method does not need a specific step for drying the kernel. Thanks to this feature, the process is quicker and simpler.

In particular, it has been shown that the application of heat on step ii) helps to fix the consecutives layers of adhesive liquid and flavorant without the risk for the kernel of getting excessively wet, which would be counterproductive to carry out the subsequent kernel popping.

In addition, it has been shown that by applying heat and the consecutive repetition of steps i) and ii) it is possible to adhere a larger amount of flavorant over the pericardium of the kernel without the need to use any additional product equivalent to fat or oil as in the state of art.

On the other hand, it has also been shown that when the flavoring treatment is over, the kernel has the desired humidity in order to be packaged and accordingly there is no need for a further drying step. Due to this, flavorant wastes are substantially reduced since the subsequent handling of the kernel in the drying step is avoided, which also avoids the flavorant coming off.

The claimed method permits to obtain an unpopped popcorn kernel that has a greater flavorant coating (less coating losses), and an unpopped kernel with more flavor, comprising at least 4.5% by weight of flavorant, preferably salt as flavorant, with respect to the total weight of the unpopped kernels.

According to a preferred embodiment, in step i), the portion of adhesive liquid comprises a composition including water and an adhesive selected from a maltodextrin and a food gum (e.g. arabic gum or shellac gum), or a mixture thereof.

According to another embodiment, in step i) the portion of adhesive liquid comprises a composition including water and an adhesive selected from starch, cellulose and dextrose, or a mixture thereof.

Preferably, said adhesive liquid also comprises a flavorant.

It has been observed that the addition of flavorant in the adhesive liquid increases the flavor fixation.

Advantageously, at the end of the method, after step iii), the added amount of powder flavorant is equal or higher than 5.0 g per 100 g of unpopped corn kernels, said flavorant being preferably salt. This amount of powder flavorant assures the obtention of a coating film of suitable thickness and retention.

Again preferably, in step iii), said steps i) and ii) are repeated from 4 to 8 times each. Thus, a coating film with multiple flavorant layers which have been fixed by multiple adhesive layers is obtained such that said film has a good adhesion and an optimum flavor degree.

Advantageously, the repetition of any of steps i) and ii) is carried out in a time interval lower than 4 minutes.

It has been observed that this brief time interval is enough to fix a flavorant and adhesive liquid layer in optimal conditions, so that the method is very quick.

Preferably, before step i), a step for pre-heating the kernels at a temperature from 40° C. to 50° C. is carried out.

It has been observed that this step affects very positively in reducing the waste of flavorant of the process.

Advantageously, before the kernel pre-heating step, a step for treating said kernels with an alkaline solution to increase the permeability of the hull of the kernels is carried out.

Therefore, the fixation of the adhesive liquid on the kernels is favored.

Again preferably, in steps ii) and iii), said temperature is from 55° C. to 65° C.

It has been observed that this temperature range favors very significantly the fixation of the flavorant and the adhesive.

Advantageously, step iii) is carried out keeping the kernels in a continuous movement.

According to one embodiment, in step ii), said flavorant portion comprises salt, preferably powder salt.

In the present invention, by “salt” is taken to mean common salt or sodium chloride, a low sodium salt such as potassium chloride or a special salt or modified in its crystalline structure derived from said common salt or said low sodium salt, or a mixture thereof.

According to another embodiment, in said step ii) said portion of flavorant comprises a flavor enhancer substance or compound selected from a gluconate, a glutamate, a guanylate, an inosylate, a bicarbonate, a yeast or an enzyme (e.g. a protease or a lipase), or a mixture thereof.

According to another embodiment, in step ii), said flavorant portion comprises a sugar or a sweetener, preferably a sugar or sweetener in liquid state.

In the present invention, by “sugar” is taken to mean a mono- or disaccharide carbohydrate in liquid or solid form, preferably a carbohydrate selected from a sucrose, a glucose, a fructose, a galactose, a maltose, a trehalose, a palatinose, or a mixture thereof.

By “sweetener” is taken to mean a food additive, preferably an additive comprising a liquid or solid substance or compound other than the sugar providing the sweet flavor, such as for example, a polyol, a sucralose, a saccharin, an aspartame, a steviol glycoside, or a mixture thereof.

Advantageously, in step ii), said flavorant portion also comprises an aroma, preferably an aroma substitute of the fat.

By “aroma” is taken to mean a food additive in liquid or solid form used with the purpose of providing flavor to the kernel.

Preferably, after step iii), the packaging of the unpopped corn kernels with no fat or oil is carried out.

Advantageously, before carrying out the packaging step, a step of cooling the already coated kernel by means of a forced air stream is carried out, said step being performed in a discharge hopper for said kernel provided with holes for the air stream.

Thus, the already kernel is cooled without the need to move it, which significantly reduces the lost of kernel coating.

The process of the present invention permits to obtain a flavored unpopped popcorn that can be packaged directly in microwave packages with no fat or oil, or to use e.g. in hot air machines, to obtain popped popcorn directly flavored.

Differently from the state of the art processes, it has been observed that the unpopped kernels treated with the process of the present invention have a higher flavorant proportion that persists during the packaging phase and the expansion of the kernels, so that it is not necessary to use fat or oil when the product is packaged.

In the present invention, by “unpopped popcorn kernels” is taken to mean complete corn kernels (Zea mays sp) suitable for being popped including pericardium, corneum endosperm, starchy endosperm and embryo.

By “coating film” is taken to mean a coating applied by a plurality of layers over the most external surface of the kernel, i.e. over the pericardium, without transforming or altering the latter, assuring at any time the integrity of the corn kernel until it is needed to be transformed into a popcorn.

By “adhesive” is taken to mean a food additive, preferably, and additive comprising a substance or compound with the purpose of fixing a second substance or compound to a surface without said second substance or compound loosing its basic organoleptic properties.

By “flavorant” is taken to mean an ingredient or food additive comprising a liquid and/or solid substance or group of substances providing flavor to a matrix, in the present case an unpopped corn kernel.

In the present invention, the flavorant may comprise a salt, a flavor enhancer, an aroma, a sugar and/or sweetener, or a mixture thereof.

### DESCRIPTION OF EXAMPLES

Hereinafter a non-limitative example of one preferred embodiment of the process of the present invention which uses common salt as favorant, and a comparative example of one embodiment of a method of the state of the art are disclosed

In addition, an example for the method which uses a mixture of sweeteners is also disclosed.

### Example 1 of the Method of the Present Invention for Flavoring Unpopped Popcorn Kernels using Common Salt as Flavorant

This example was carried out with 1,500 g of unpopped popcorn kernels, 90 g of common salt or sodium chloride in powder as flavorant and 72 g of adhesive liquid.

The adhesive liquid consisted on an aqueous solution of maltodextrin that presented the following composition by weight:
74% of water
17% of common salt (flavorant)
10% of maltodextrin (adhesive).

The method was started heating the kernel on a pan-type coater at a temperature of 43° C. and keeping the kernel under a continuous movement inside the pan-type coater.

Once reached the temperature of 43° C., a portion of 12 g of the aqueous solution of maltodextrin was applied on the moving kernels. In the described embodiment, this aqueous solution was applied spraying the liquid on the kernels, but it could be done by any suitable means.

Immediately after applying the adhesive solution, the temperature of the kernel increased up to 60° C. providing heat to the pan-type coater, and a portion of 15 g of powder salt was applied to the kernel.

The pan-type coater was kept under continued movement until it was observed that the product was moving uniformly and the water from the adhesive solutions had been evaporated. About thirty seconds were necessary.

Then, the step of adding a portion of adhesive liquid was repeated, applying other 12 g of the aqueous solution of maltodextrin and, immediately after, other 15 g of salt. In this repetition step it was shown that the adhesive liquid and the flavorant were very effectively retained in the kernel, attributing this effect to the fact that the new addition was performed over a dry kernel surface (evaporation of water from the previous step)

In total, the steps of adding adhesive liquid and flavorant were repeated cyclically until each of said steps was carried out six times, using in each repetition 12 g of aqueous solution and 15 g of common salt.

During the whole process the kernels were kept moving inside the pan-type coater and at temperature about 60° C. The interval between repetitions was lower than 1 minute.

After the last repetition, the kernels presented an uniform coating film constituted by a plurality of adhesive and flavorant layers and a desired humidity not higher than 15% by weight.

Then the product was packaged with no fat and oil and in packages for microwaves, and it was popped in a microwave oven at 900 W during two minutes.

### Example 2 of the State of the Art Method for Flavoring Unpopped Popcorn Kernels

This example was carried out with 1,500 g of unpopped popcorn kernels, 90 g of common salt or sodium chloride in powder as flavorant and 72 g of adhesive liquid.

The adhesive liquid consisted on an aqueous solution of maltodextrin that presented the following composition by weight:
74% of water
17% of common salt (flavorant)
10% of maltodextrin (adhesive)

The method was started placing the corn on a heated pan-type coater under movement. Then, 72 g of adhesive aqueous solution were applied on the kernel progressively and uniformly, keeping the pan-type coater heated and the kernels moving.

Once applied the adhesive solution, the kernels were moved to a second pan-type coater and 90 g of powder salt were added uniformly, keeping the kernels at room temperature.

After about four minutes, it was observed that the pan-type coater moved the product uniformly, so that it was estimated that the coating step of the kernels was already finished.

Then, the kernels coated with flavorant and adhesive solution were dried. To this end, the kernels were kept moving in the second pan-type coater, at a temperature of 65° C., during about ten minutes. After this time, the kernels had the desired humidity (not higher than 15% by weight).

Finally, the kernels were packaged with no fat and oil and they were popped in a microwave oven at 900 W during two minutes.

### Result Comparison of Example 1 and Example 2

To compare both processes, in each of the executed examples data from the following parameters were taken:
common salt waste in the pan-type coater
coating losses percentage of the popped kernels
common salt percentage of the unpopped kernels
common salt percentage of the popped kernels.

Also a organoleptic analysis of the popped popcorn to value its taste was carried out.

Hereinafter a table with the results of said parameters for each of the executed examples is attached.

| | Example 1: | |
|---|---|---|
| | Method of the | Example 2: State |
| Parameter | invention | of the art method |
| Salt waste (g) | 12.6 | 50.1 |
| Coating losses of the popped | 1.2 | 2.0 |
| kernels (%) | | |
| Salt of unpopped kernels (%) | 4.82 | 2.49 |
| Salt of popped kernels (%) | 3.67 | 1.98 |

As shown in the attached table, the waste of salt of example 1 of the process of the present invention is lower than the waste obtained in the example 2 of the state of the art process.

On the other hand, the kernels obtained with the process of the present invention have less coating losses and a higher percentage by weight of flavorant (salt). Particularly, it must be pointed out that the popped kernels obtained with the process of the present invention have a very higher content of salt, which means a stronger taste confirming the organoleptic analysis.

Furthermore, it has been observed that the process of example 1 is so much simpler and quicker than the process of the state of the art example 2, because of the coating process is carried out in less than ten minutes.

### Example 3 of the Method of the Present Invention for Flavoring Unpopped Popcorn Kernels by using Sweeteners as Flavorant

This example was carried out with 1,500 g of unpopped popcorn kernels, 100 g of a mixture of powder sweeteners and 60 g of liquid adhesive.

The adhesive liquid consisted on an aqueous solution of maltodextrin that presented the following composition by weight:
85% of water
5% of a mixture of sweeteners (flavorant)
10% of maltodextrin (adhesive)

The method was started by heating the corn on a pan-type coater at a temperature of 48° C. and keeping the kernel under continuous movement inside the pan-type coater.

Once the temperature reached 48° C., a portion of 15 g of aqueous solution of maltodextrin was applied over the kernel under movement. In this example, this aqueous solution was applied by spraying the liquid over the kernel but it could be applied by any other known means.

Immediately after applying the adhesive solution, the kernel temperature was increased until 60° C. by providing heat to the pan-type coater and a portion of 25 g of the mixture of powder sweeteners was applied over the kernel.

The pan-type coater was kept under continuous movement until at around 45 seconds when the product was moving uniformly and the water from the aqueous adhesive solution had been evaporated.

Then, the step of adding a portion of adhesive liquid was repeated, by further applying 15 g of the aqueous solution of maltodextrin and, immediately after, further 25 g of the mixture of powder sweeteners.

In total, the steps of adding adhesive liquid and flavorant were repeated cyclically until each of said steps was carried out four times, using in each repetition 15 g of aqueous solution and 25 g of the mixture of powder sweeteners.

During the whole method the kernels were kept under movement inside the pan-type coater and at temperature about 60° C. The interval between repetitions was lower than 1 minute.

After the last repetition, the kernels presented an uniform coating film constituted by a plurality of adhesive and flavorant layers and a desired humidity not higher than 15% by weight.

Then the product was packaged with no fat and oil and in packages for microwaves, and the kernel was popped in a microwave.

In this case, as in example 1 above, the sweetener waste in the pan-type coater were very low, obtaining thereby a popped kernel with very few losses of coating.

Even though two examples of a specific embodiment of the present invention has been described and shown, it is apparent that a person skilled in the art can introduce variations and modifications, or he/she can substitute the details by other technically equivalent ones, without departing from the scope of protection defined by the attached claims.

For example, even though reference is made in the present specification to two examples which use common salt and sweetener as flavorant, the same method could be done by using other flavorants or combining the application of several flavorants, using optionally an aroma substituting the fat or other type of aroma, such as for example a natural aroma in order to increase the perception of salt. Similarly, even though in the described examples 1 and 2 maltodextrin has been used as adhesive, similar results could be obtained using another kind of equivalent adhesive, such as e.g. a food gum. On the other hand, even though in the described examples an aqueous solution has been used, similar results could be obtained using an aqueous suspension of adhesive and/or flavorant.

What is claimed is:

1. Method for flavoring unpopped popcorn kernels comprising the steps of:
i) applying a portion of adhesive liquid on the unpopped kernels, comprising said adhesive liquid an aqueous based adhesive composition;
ii) after step i), applying a portion of flavorant on said kernels, keeping said kernels under movement at a temperature from 50° C. to 70° C. for enough time in order to allow the evaporation of water from said adhesive liquid,
iii) cyclically repeating steps i) and ii) until each of said steps is carried out at least two times while said kernels are kept at a temperature from 50° C. to 70° C., the repetition of said steps i) and ii) allowing the formation of a coating film over the kernel, said coating film comprising a plurality of layers of adhesive and flavorant.

2. Method according to claim 1, wherein, in step i), said portion of liquid comprises a composition including water and an adhesive selected from maltodrextrin and food gum, or a mixture thereof.

3. Method according to claim 1, wherein said adhesive liquid comprises a flavorant.

4. Method according to claim 1, wherein, in step iii), said steps i) and ii) are repeated from 4 to 8 times each.

5. Method according to claim 1, wherein, in step iii), the repetition of any of steps i) and ii) is carried out in a time interval lower than 4 minutes.

6. Method according to claim 1, wherein, before step i), a step of preheating said kernels at a temperature from 40° C. to 50° C. is carried out.

7. Method according to claim 6, wherein, before the step of preheating the kernels, a step of treating said kernels with an alkaline solution to increase the permeability of the hull of the kernel is carried out.

8. Method according to claim 1, wherein, in steps ii) and iii), said temperature is from 55° C. to 65° C.

9. Method according to claim 1, wherein step iii) is carried out keeping the kernels under a continuous movement.

10. Method according to claim 1, wherein, in step ii), said flavorant portion comprises salt, preferably powder salt.

11. Method according to claim 1, wherein said portion of flavorant comprises a flavor enhancer substance or compound, preferably a flavor enhancer substance or compound selected from a gluconate, a glutamate, a guanylate, an inosylate, a bicarbonate, a yeast or an enzyme, or a mixture thereof.

12. Method according to claim 1, wherein, in step ii), said flavorant portion comprises a sugar or a sweetener.

13. Method according to claim 1, wherein, in step ii), said flavorant portion comprises an aroma, preferably an aroma substitute of the fat.

14. Method according to claim 1, wherein, after step iii), a step of packaging the unpopped corn kernels with no fat or oil is carried out.

15. Method according to claim 1, wherein before carrying out the packaging step, a step of cooling the already coated kernel by means of a forced air stream is carried out, said step being performed in a discharge hopper for said kernel provided with holes for the air stream.

16. Unpopped popcorn kernel product obtained by the method of claim 1, characterized in that said kernels comprise at least a 4.5% by weight of flavorant with respect to the total weight of unpopped kernel.

17. Product according to claim 16, comprising a package for microwaves including a charge of said unpopped corn kernels.
